(19) United States
(12) Patent Application Publication
(10) Pub. No.: US 2005/0150261 A1
(43) Pub. Date: Jul. 14, 2005

(54) Garment steamer with improved heater and variable steam output

(75) Inventor: Vito James Carlucci, Stratford, CT (US)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/929,880

(22) Filed: Aug. 30, 2004

Related U.S. Application Data
(60) Provisional application No. 60/536,415, filed on Jan. 14, 2004.

(51) Int. Cl. D06C 7/00; A01J 11/04; A01J 13/00; D06F 75/00; A01J 15/14

(52) U.S. Cl. 68/222; 236/15 BB

(57) ABSTRACT

A steamer for steaming and/or steam cleaning an object. The steamer includes a reservoir for containing a liquid therein, a pressurized boiler system for generating steam under pressure from a portion of the liquid in the reservoir, a thermostatic control device for controlling a flow rate of the liquid delivered from the reservoir to the pressurized boiler system, and at least one steam output discharge port having a variable aperture size in fluid communication with the output of the pressurized boiler system.

### CROSS-REFERENCE TO RELATED APPLICATIONS

This application claims priority to U.S. Provisional Patent Application Ser. No. 60/536,415 filed on Jan. 14, 2004.

### BACKGROUND OF THE INVENTION

1. Field of the Invention

The present invention relates to an electric steamer. More particularly, the present invention relates to an electric garment steamer that has a hose and a wand for providing a consistent, controlled steam output.

2. Description of Related Art

Steam generating devices for applying steam are particularly useful in removing wrinkles and improving the appearance of hanging garments, draperies, upholstery, and other items made of fabric. A garment steamer that has a boiler in a reservoir of water, a hand-held wand, and flexible tubing providing a pathway for steam generated by the boiler from the reservoir to a hand-held wand is known. Such appliances have been used to steam the wrinkles out of garments, cloth, fabric, and the like. Such prior art garment steamers typically have an immersion-type resistance heater in the reservoir of water. The heater is energized to boil the water to produce steam. The steam is guided to the hand-held wand via the flexible tubing. One of the disadvantages of such garment steamers is that the time and energy required to heat the relatively large reservoir of water to produce the steam is considerable.

In an attempt to reduce the time required to produce steam by heating the reservoir of water to boiling, a known alternative steamer has a smaller secondary chamber for holding the water that is heated to boiling. The water is typically fed by gravity from the main reservoir to the secondary chamber via a small diameter pipe, siphoning, or a wicking action.

A disadvantage of such garment steamers is that the rate of delivery for the water from the reservoir to the secondary chamber is inefficient, varied, and not particularly well-matched to the boiling rate of the boiler. Being gravity-fed, the rate of delivery varies as the amount of water in the reservoir is consumed by the boiler. The boiler is typically thermostatically controlled to operate at a single high output level. The boiler is also thermostatically controlled to switch off the instant the water in the boiler is boiled away (i.e., boiled dry).

The typically varied flow of ambient temperature water from the reservoir to the secondary chamber results in a garment steamer having a decreased initial heat-up time but a cyclical heating and steaming pattern of operation. The garment steamer cycles between heating the water in the secondary chamber to a boiling temperature and outputting steam since the water temperature in the secondary chamber reduces as additional water is added to the secondary chamber from the reservoir. Reducing the water temperature in the secondary chamber has the undesired effect of reducing and/or totally stopping the steam output of the garment steamer. As a result of the cyclical steam generating nature of such steamers, the efficiency and effectiveness of the garment steamer at removing wrinkles from garments and fabrics is compromised.

Another disadvantage in prior garment steamers is that the garment steamers typically provide an inconsistent steam output that does not provide sufficient hotness, dryness, and pressure to effectively clean many items, such as upholstery. Effective cleaning of many items, such as upholstery, requires a hotter, dryer steam, at a higher jet speed. However, such a steam output can only be produced by a pressurized steam system.

In a prior type of steam cleaner, a pressurized boiler system is used to produce pressurized steam for steam cleaning. The pressurized boiler is a closed system, protected from atmospheric pressure by pressure relief valves that do not permit a gravity-fed flow of water to the boiler. Due to the need to keep the boiler system pressurized (i.e., closed), such steam cleaners do not have a reservoir for supplying a large reserve of water to the boiler system. Consequently, known steam cleaners that have a pressurized boiler system typically not only have a relatively short initial heating time until steam production starts but also have a relatively short operating time due to the limited water capacity of the pressurized boiler system.

Accordingly, there is a need for a garment steamer and steam cleaning apparatus that delivers a controllable steam output volume for a long period of time at both a low pressure and a high pressure.

### BRIEF SUMMARY OF THE INVENTION

It is an object of the present invention to provide a steamer for steaming garments.

It is another object of the present invention to provide such a steamer for steam cleaning objects.

It is yet another object of the present invention to provide such a steamer that has a substantially constant steam output.

It is still another object of the present invention to provide such a steamer that has a controllable steam output.

It is a further object of the present invention to provide such a steamer that has an adjustable steam discharge output portion for varying the rate, pressure, and other characteristics of the discharged steam.

These and other objects and advantages of the present invention are provided by a steamer including a reservoir for containing a liquid therein, a pressurized boiler system for generating steam under pressure from a portion of the liquid contained in the reservoir, a wand, and at least one steam output discharge port having a selectively variable aperture size. The pressurized boiler system has an input thereof connected to the reservoir and an output thereof in fluid communication with the wand. The at least one steam output discharge port is in fluid communication with the wand. Preferably, varying the aperture size of the at least one steam output discharge port varies a characteristic of the steam output by the steamer such as the temperature, pressure, and pattern of the steam output.

The steamer of the present invention preferably includes functionality to provide a substantially constant delivery of steam. The reservoir is preferably detachable from the steamer to facilitate easy filling thereof. The steamer preferably includes one or more attachments for performing various fabric treatment operations, such as, but not limited to, brushing, combing, flattening, and scrubbing fabric, and removing lint therefrom.

### BRIEF DESCRIPTION OF THE DRAWINGS

FIG. 1 is a plan view of a steamer in accordance with the present invention;

FIG. 2 is a partial sectional view of a hand-piece of the steamer of FIG. 1;

FIG. 3 is a partial sectional view of a wand assembly of the steamer of FIG. 1, including an ozone generator; and

FIG. 4 is a plan view of a disc having a number of steam output discharge ports therein, in accordance with present invention.

### DETAILED DESCRIPTION OF THE INVENTION

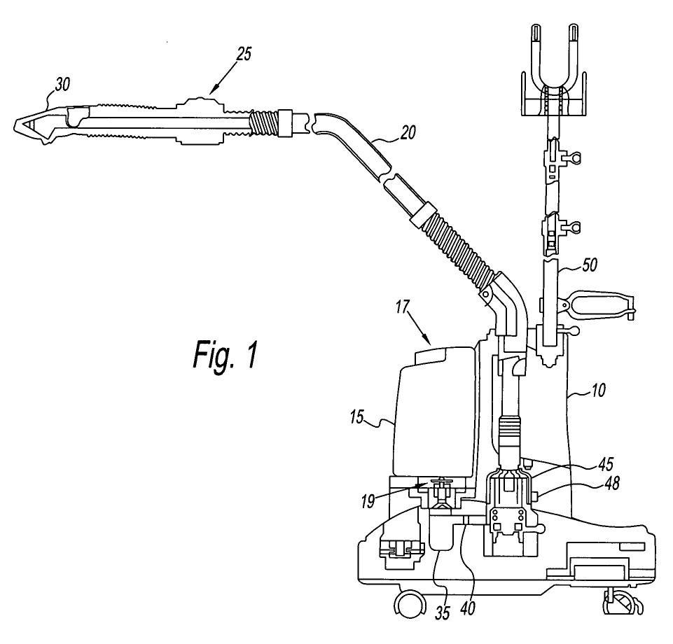

Referring to the figures and, in particular, FIG. 1, there is shown a steamer generally represented by reference numeral 5. Steamer 5 has a housing 10 that houses, and preferably encloses, a pump 35 and a pressurized boiler system 45. A hose 20 is connected to the housing in fluid communication with the pressurized boiler system 45. A wand 25 is connected to a working end of the hose and has a hand-piece 30 connected thereto. Preferably, the wand, hose, and hand-piece are removably connected together. The combined wand 25 and hand-piece 30 can be manipulated to apply steam to a particular item for steaming and/or steam cleaning.

Housing 10 provides a mounting location for reservoir 15 on or in steamer 5. Reservoir 15 defines a relatively large space therein for containing a liquid, preferably water. Reservoir 15 holds the water that is heated and discharged by the steamer. The relatively large water containing capacity of reservoir 15 alleviates the need to repeatedly re-fill the reservoir, even when continuously operating the steamer for an extended period of time.

In an aspect hereof, reservoir 15 is preferably detachable from housing 10. Reservoir 15 can be detached from housing 10 to facilitate convenient filling thereof with water. With the reservoir being detachable from the housing, only the reservoir needs to be placed in the vicinity of the water source for the purpose of filling the reservoir. Accordingly, the convenience and ease of operating steamer 5 is enhanced by the detachable reservoir.

Reservoir 15 preferably has an inlet port 17 that provides an input point for introducing water into the reservoir. Reservoir 15 preferably has an outlet port 19 that provides an outlet point for releasing water from the reservoir. Inlet and outlet ports 17 and 19, respectively, may be closed or sealed by any one or combination of known methods for providing a preferably non-permanent and water-tight sealing system.

Pump 35 is in fluid communication with reservoir 15 and pressurized boiler system 45. An inlet of the pump is in fluid communication with reservoir 15 and an outlet of the pump is in fluid communication with pressurized boiler system 45. Pump 35 pumps water from reservoir 15 to pressurized boiler system 45.

Pressurized boiler system 45 heats the water delivered thereto by pump 35 under pressure. The operating pressures of pressurized boiler system 45 are generally greater than the ambient environment's atmospheric pressure. In order to maintain the pressure within pressurized boiler system 45, the pressurized boiler system is isolated from ambient atmospheric pressures by being maintained as a closed system. The pressurized boiler system may be closed using a variety of devices, including but not limited to, mechanical valves, seals and switches; electronic valves and switches; electromechanical valves, seals and switches; or any combinations thereof.

A valve or flow control device 40 is provided to isolate pressurized boiler system 45 from portions of steamer 5 that are upstream from the pressurized boiling system. By isolating pressurized boiler system 45 from, for example, pump 35 and reservoir 15, the portions of steamer 5 subjected to increased pressures are limited. Accordingly, portions of steamer 5 upstream from valve 35 may be accessed without compromising the pressurized boiling system.

For example, reservoir 15 may be opened and/or detached from housing 10 for the purpose of the filling the reservoir with water without impacting the pressurized boiling system. In this manner, reservoir 15 may be re-filled without interrupting the operation of the steamer and obviates the need to de-pressurize and allow the steamer to cool down prior to accessing the reservoir.

The cost, life cycle, and reliability of steamer 5 may be enhanced since the portions of the steamer subjected to high operating pressures is limited.

The pressurized boiler system preferably has a high density heater (not shown) that can heat a source of water in contact therewith to boiling to produce steam in a short period of time (i.e., practically instantaneously). It should be appreciated that the particular type of heater used may vary and can include any type of heater compatible with other aspects of the present invention. A key aspect of the heater is the heater's ability to heat the water from a liquid state to a gaseous state in a short period of time. The heater may, preferably, have an operating output power of about 500 to about 1875 watts.

In an aspect hereof, a thermostatic control device 48 is provided near or on pressurized boiler system 45 to monitor the temperature of the water in the pressurized boiling system. The thermostatic control device may include a mechanical thermostat, an electro-mechanical thermostat device, and an electronic temperature sensor or system. The thermostatic control device 48 is provided to control the heating of the water in the pressurized boiling system. Preferably, pressurized boiler system 45 has a temperature set point to heat the water delivered thereto to boiling very quickly. For example, the temperature set point for the thermostatic control device is preferably set to about 100° C. to about 125° C.

In order to accurately control the production of steam by pressurized boiler system 45, the amount and flow rate of water delivered to the pressurized boiler system and the heating capacity of the pressurized boiler system are accurately controlled according to the teachings of the present invention. Preferably, the amount and flow rate of water delivered to the pressurized boiler system 45 and the heating capacity of the pressurized boiler system are controlled by the thermostatic control device 48. In addition to providing the set temperature for controlling the heating capacity of the heater, the thermostatic control device 48 controls the rate at which a calibrated amount of water is introduced to the pressurized boiler system 45. That is, the thermostatic control device 48 controls the temperature setting of the heater of the pressurized boiler system and controls the amount and rate at which the water is delivered to the pressurized boiler system such that the water delivered to the pressurized boiler system is substantially heated to a gaseous state (i.e., steam) in a very fast period of time.

As an example, the thermostatic control device 48 may control pump 35 and/or valve 40 to permit about 25 to about 30 milliliters of water from reservoir 15 to flow, in about 3 seconds, to pressurized boiler system 45. The pressurized boiler system 45 has a set temperature of 125° C. and a heater operating at 1500 watts to heat the water to steam in substantially an instantaneous manner.

It should be appreciated that the thermostatic control device 48 may include mechanical, electromechanical, and electronic components to accomplish the various functions associated therewith. For example, the thermostatic control device 48 can have mechanical sensors and actuators, a microprocessor, a relay, and any number of other types of control mechanisms. The thermostatic control device 48 can preferably be selectively controlled to vary, for example, the volume of steam produced during a given unit of time, the amount of water in the steam produced, and the velocity of the steam output.

In one aspect of the present invention, the thermostatic control device 48 can selectively control the operation of pump 35 in a timed manner. Preferably, the pump 35 is controlled to pump an amount of water from the reservoir at timed intervals. A timer (mechanical and/or electronic) (not shown) may be used to control and/or measure the length of the timed interval. The length of the timed interval is preferably variable and may correspond to the heating capacity of the heater, the flow rate the water delivered to the pressurized boiler system 45, the amount of water delivered to the pressurized boiling system, as well as other factors such as the switching speed(s) and response time(s) of pump 35, valve 40, the pressurized boiler system 45, and the thermostatic control device 48.

In another aspect hereof, an outlet of the pressurized boiler system 45 is in fluid communication with hose 20, which is in turn in fluid communication with wand 25 and hand-piece 30. In this manner, the steam produced by pressurized boiler system 45 is guided from the pressurized boiler system to the hand-piece for applying the steam output therefrom to an object for steaming and/or steam cleaning.

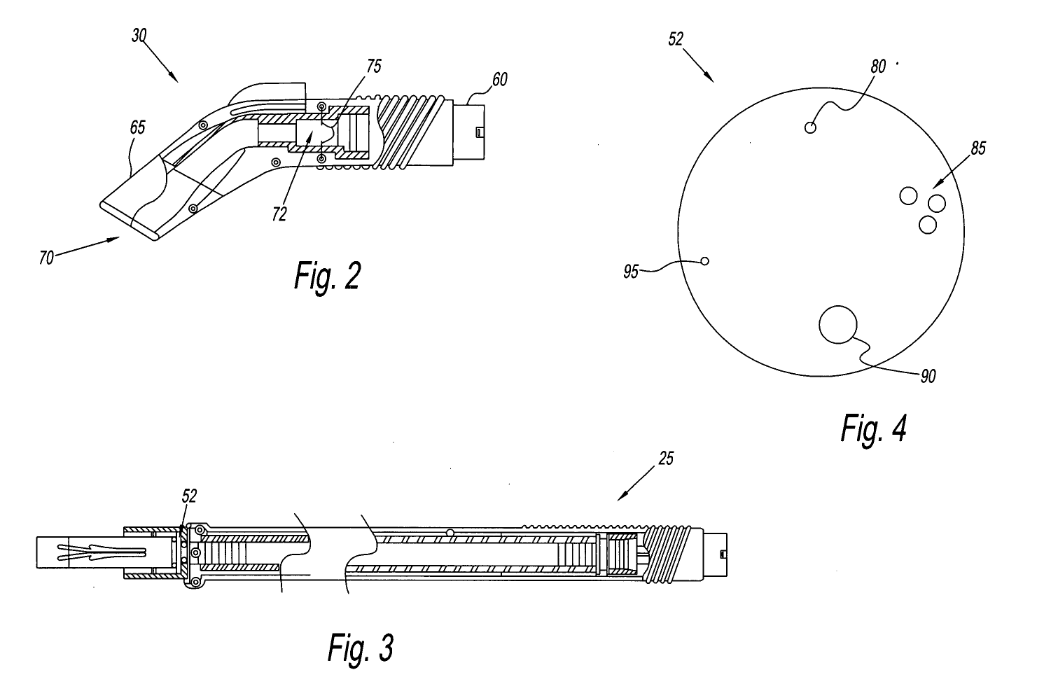

Referring to FIGS. 2, 3, and 4, the hand-piece 30 and wand 25 are shown in greater detail. The hand-piece 30 has one end 60 for connecting to wand 25 and an outlet end 65 from which steam generated by the steamer is ultimately discharged. The steam is discharged from hand-piece opening 72. Preferably, inside wand 25 or hand-piece 30 is at least one restrictive orifice, valve or jet aperture. The at least one aperture, in a preferred but not limiting embodiment thereof, is depicted in FIG. 4 as an array of steam output discharge ports 80, 85, 90, and 95. Steam output discharge ports 80, 85, 90, and 95 preferably maintain the steam produced by the steamer at the desired system pressure until the steam exits the hand-piece at opening 72.

In an aspect of the present invention, the steam output discharge ports (80, 85, 90, and 95) may have a variable diameter and function as at least an aid in controlling the temperature and pressure of the output steam in order to effect either a lower temperature, wet steam or a higher temperature, dry steam.

The variable diameter steam output discharge ports act to control the pressure of the steam at the hand-piece 30. The steam output discharge ports are located, preferably, on a steam output controller 52. Steam output controller 52 is provided to selectively position at least one of steam output discharge ports 80, 85, 90, and 95 in the path of the steam produced by the steamer. Steam output controller 52 is preferably a sealing and rotatable disc having steam output discharge ports 80, 85, 90, and 95 arranged in an array thereon. Steam output controller 52 can preferably be positively set to any one of a number of discrete positions to position any one of the output discharge ports 80, 85, 90, and 95 in the path of the steam. The various steam output discharge ports 80, 85, 90, and 95 are revealed or closed to the steam pathway, depending on the angular position of the disc 52.

It should be appreciated that the number, diameter and particular arrangement of the steam output discharge ports 80, 85, 90, and 95 can be modified with various known valve designs placed in the path of the steam in wand 25 to gauge and vary the resistance, temperature, pressure and output pattern of the steam. Various steam output discharge port configurations, such as but not limited to, a globe valve, an iris shutter, and a sliding panel can be used to alter the characteristics of the steam output.

In yet another aspect of the present invention, an ionizing device 72 may be placed in the path of the steam output to vary the characteristics thereof. The ionizing device 72 may be a high voltage corona arc established by any known means such as, for example, opposing, spaced apart electrodes 75 or a UV (ultra-violet) light source placed in the path of the output steam. Such ionizing devices are purported to ionize and atomize the water droplets in the effluent and produce a finer or coarser mist. Preferably, the ionizing device can be selectively actuated.

In another aspect of the present invention, a second thermostatic device (not shown) may be provided to prevent an over-heating condition of the steamer in the event, for example, the steamer exhausts its water supply. The second thermostatic device may preferably be set about thirty degrees above the set temperature of the pressurized boiler system 45.

It should also be appreciated by those skilled in the art that the particular steamer functions and other aspects of the teachings herein are but examples of the present invention. Thus, they do not limit the scope or variety of applications that the present invention may be suitably implemented. Thus, it should be understood that the foregoing description is only illustrative of a present implementation of the teachings herein. Various alternatives and modification may be devised by those skilled in the art without departing from the present invention. Accordingly, the present invention is intended to embrace all such alternatives, modifications, and variances that fall within the scope of the disclosure herein.

1. A steamer comprising:
a reservoir for containing a liquid therein;
a pressurized boiler system for generating steam under pressure from a portion of said liquid in said reservoir, said pressurized boiler having an input connected to said reservoir and an output;
a thermostatic control device for controlling a liquid flow rate of the liquid delivered from said reservoir to said pressurized boiler system, and a heating temperature setting for said pressurized boiler system; and
at least one steam output discharge port having a selectable aperture size in fluid communication with said output of said pressurized boiler system.

2. The steamer of claim 1, wherein said pressurized boiler system has a water containing capacity smaller than a water containing capacity of said reservoir.

3. The steamer of claim 1, further comprising an assembly for pumping said liquid from said reservoir to said pressurized boiler system.

4. The steamer of claim 1, further comprising a flow control device for isolating said pump assembly from said pressurized boiler system.

5. The steamer of claim 1, further comprising a steam output controller for selectively controlling said aperture size of said at least one steam output discharge port.

6. The steamer of claim 1, wherein varying said aperture size modifies at least one of the characteristics of the output steam selected from the group consisting of: temperature, pressure, flow rate, and pattern.

7. The steamer of claim 1, further comprising an ionizer for ionizing at least a portion of the steam output by said steamer.

8. The steamer of claim 1, wherein said thermostatic control device controls a liquid flow rate of the liquid delivered from said reservoir to said pressurized boiler system.

9. The steamer of claim 1, wherein said thermostatic control device controls a heating capacity for said pressurized boiler system.

10. The steamer of claim 1, wherein said thermostatic control device is a thermostat or an electronic temperature control device.

11. A steamer comprising:
a reservoir for containing a liquid therein;
a pressurized boiler system for generating steam under pressure from a portion of said liquid in said reservoir, said pressurized boiler having an input connected to said reservoir and an output;
an assembly for pumping said liquid from said reservoir to said pressurized boiler system;
a flow control device for isolating said pump assembly from said pressurized boiler system;
a thermostatic control device for controlling a liquid flow rate of the liquid delivered from said reservoir to said pressurized boiler system, and a heating temperature setting for said pressurized boiler system; and
at least one steam output discharge port having a selectable aperture size in fluid communication with said output of said pressurized boiler system.

12. The steamer of claim 11, further comprising a steam output controller for selectively controlling said aperture size of said at least one steam output discharge port.

13. The steamer of claim 11, further comprising an ionizer for ionizing at least a portion of the steam output by said steamer.

14. The steamer of claim 11, wherein said thermostatic control device controls a liquid flow rate of the liquid delivered from said reservoir to said pressurized boiler system.

15. The steamer of claim 11, wherein said thermostatic control device controls a heating capacity for said pressurized boiler system.

16. The steamer of claim 11, wherein said thermostatic control device is a thermostat or an electronic temperature control device.
